(19) United States
(12) Patent Application Publication
(10) Pub. No.: US 2005/0038672 A1
(43) Pub. Date: Feb. 17, 2005

(54) Method of providing health care

(76) Inventors: Ajai Sawhney, Tucson, AZ (US); J.L. Rush, Gallup, NM (US)

Correspondence Address: Mark E. Ogram, 7454 E. Broadway, Ste. 203, Tucson, AZ, 85710, US

(21) Appl. No.: 10/642,444

(22) Filed: Aug. 15, 2003

(51) Int. Cl. G06F 17/60

(52) U.S. Cl. 705/2

(57) ABSTRACT

A method of providing medical treatment in which a patient is received in an emergency situation and is properly diagnosed. Diagnosis includes: taking a medical history of the patient; conducting a physical examination of the patient; and, if necessary, performing tests on the patient. All of the diagnosis is digitally stored and is made accessible to the primary care physician and also to a receiving hospital or long-care facility. The patient is not kept at the invention's facility for more than twenty-four hours.

Priority for this application is claimed from U.S. Provisional Patent Application No. 60/410,640 filed on Sep. 13, 2002 and entitled “Emergency Medical Center System with Safetynet”.

### BACKGROUND OF THE INVENTION

One of the biggest problems in emergency rooms and other healthcare facilities is efficiency of patient information flow. Patients are moving through a health care system faster than the patient's information; thereby creating a frustration on both the patient and the care-giver. The technology exists for rapid diagnosis and treatment; but, if the patient's information is slow in coming, all of this is mute because without the base information, diagnosis and treatment cannot be done. In the current environment, information often lags behind the patient by as much as four hours.

This problem is no more evident than in the emergency room. Complaints abound about the long wait before even seeing a physician, and then there is a longer wait for the diagnosis. The biggest reason for the delay is the extended wait for a patient results.

The entire healthcare industry is faced with new pressures on the delivery of its services. Healthcare consumers today demand a choice on healthcare Insurance companies dictate to healthcare providers what services can and can't be offered. The consumer wants to be able to dictate how their healthcare is delivered and demand this service be promptly administered.

There is a growing recognition that there must be a bridge between the hospitalized patients and the private physician. Typically, the emergency room physicians provide this bridge; but, these physicians are hampered with the same informational delay problems.

It is clear that there is a need for improvement in the informational flow within the health-care industry.

### SUMMARY OF THE INVENTION

The present invention creates a method of health-care delivery centered around an emergency room. Within this context, the term “emergency” means any condition that requires urgent medical treatment (i.e. cardiac arrest) or any procedure that must be performed immediately (i.e. cardiopulmonary resuscitation).

In order to be efficient, emergency rooms must be able to triage their patients from point of contact. Within the present invention, triage is conducted at the point of contact, whether it is in the field with emergency medical services, primary care physicians or self referrals.

In one aspect of the invention, through the use of remote digital video apparatus, Physicians are able to make appropriate decisions based on patients status and condition well in advance of the arrival of the patient to the facility.

With the focus on the emergency aspect of medical care, the facility of this invention does not have an inpatient services. The method of this invention provides the needed information to the Primary care physicians and specialist by providing emergence services and the limited ability to hold a patient for observation and needed diagnostic studies without admitting the patient to a hospital.

The invention's methodology permits diagnostic and test results to be easily and rapidly communicated to the primary care physician and specialists, thereby facilitating management of care to those patents typically needing hospital admissions. Armed with the information gathered, and rapidly disseminated, admission of the patient to a hospital and or higher level of care center is facilitated without any undue delays for duplicate testing eliminated. This ensures that patients receive continuity in their care.

Ideally, all information is transferred in digital mode. The services provided by the present invention include the ability to teleconference, arrangement of hospital admissions, and obtaining the appropriate method of transport to the level of care selected.

The transfer of information is ideally accomplished even before the patient arrives at their ultimate destination. Armed with this advanced information, physicians and other healthcare providers are able to provide appropriate care immediately upon the arrival of the patient without duplicating tests or examinations.

By creating an all digital service within the present invention, data is easily communicated, highlighted, compressed, and stored. In this context, “data” includes not only patient test results, but also a variety of other related information, such as, but not limited to text/numeric data, image data, waveform data, real time physiologic data, accounting data, order entry, appointment schedule and inventory management system.

Because of the underlying digital framework for the present invention, the invention's healthcare facility is able to operate at maximum potential with the added capability of identifying any existing shortcomings or “bottlenecks”. Further, with the rapid and easy transmission of this collected data, other healthcare providers and organizations are assisted in their own delivery of health care.

The present invention utilizes technology to ensure easy access to healthcare, offer rapid assessment, diagnosis, treatment and stabilization of illness without compromise in providing efficient, safe, ethical, sound, appropriate care. Facilities utilizing the present invention's methodology are able to easily integrate with existing healthcare providers in the community, and facilitate in the management of care to our communities healthcare consumers.

One aspect of the present invention permits the facility to equip the patient with their own set of medical records on CD-ROM. This is particularly useful for patients who are traveling or changing physicians.

With the invention's use of digital memory for all data, such mundane items as billing is easily accomplished and cross checked with the actual medical records of the treatment provided.

The facility of the present invention is able to provide:
1) limited care at site of illness;
2) offer transport to higher level of care;
3) and initiate treatment at scene of illness;
4) health screening and education in under served rural areas;
5) information to a variety of locations using digital satellite communications; and,
6) access to the primary care physician and Specialist from the scene of illness.

This methodology provides a safety net for the healthcare consumer by utilizing a digital communication network between the present invention's facility, the primary care provider, and tertiary care centers.

Underlying the digital data is the use of digital diagnostic equipment within the present invention's facility. This permits the facility to assist with the management of care with the area healthcare consumers, principal care provider, or specialist. This aspect of the present invention is extremely useful in under populated areas, thereby providing not only rudimentary h healthcare, but also health screens and education utilizing advanced digital modalities. In this aspect of the invention, a continuity of care from site of triage to disposition is given. Additionally, the facility provides a medical archive repository system and billing component available for local healthcare providers and their facilities.

In this manner, the present method provides efficient, cost effective care utilizing current and new technology. Through the use of this technology, wait time is minimized and faster, more accurate communication is made with the principal care physician and any specialists who might be utilized to assist and facilitate the management of care.

Because of the invention's use of digital storage of all aspects of the patient's diagnosis, the invention is able to:

1. Monitor the efficiency of information, billing and patient flow;

2. Assess patient comfort and services;

3. Monitor education programs for both staff and patients;

4. Track efficiency of inventory control; and,

5. Monitor and assess patient to staff ratio.

The invention, together with various embodiments thereof will be more fully explained by the accompanying drawings and the following descriptions thereof.

### DRAWINGS IN BRIEF

FIG. 1 is a block diagram showing the central operation that the present invention serves with regards to the primary care physician and also with the hospital.

FIG. 2 is a flow diagram showing the flow of digital information within the preferred embodiment of the invention.

FIG. 3 is a flow-chart of the operation of the preferred embodiment of the computer operation.

### DRAWINGS IN DETAIL

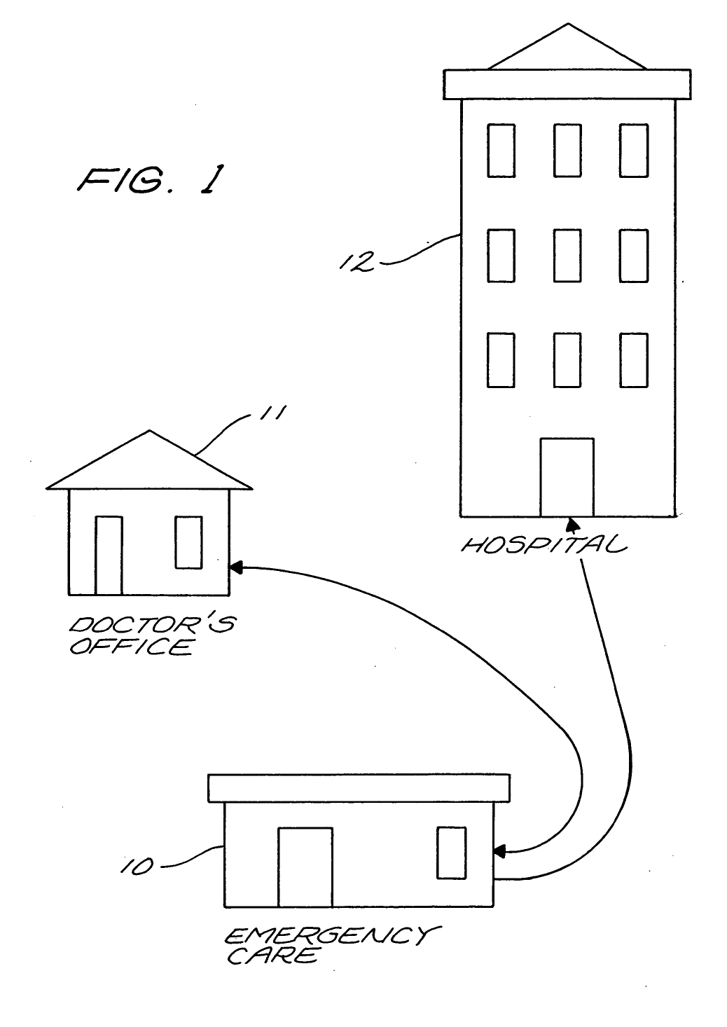

FIG. 1 is a block diagram showing the central operation that the present invention serves with regards to the primary care physician and also with the hospital.

The patient arrives at the emergency care facility 10. Emergency care facility 10 is remote from the hospital 12 and the primary care physician's office 11.

At emergency care facility 10, a complete diagnostic procedure (medical history, physical examination, and testing) is performed on the patient and is digitally stored. To assist in the diagnostic procedure, the patient's history is sent by the primary care physician 11 to the Emergency care facility 10. The results of the diagnostic procedure are shared with the primary care physician 11 and the hospital 12.

Emergency care facility 10 is equipped to observe the patient for a maximum period of twenty-four hours. At the end of this time, the patient is either released or is transported to hospital 12.

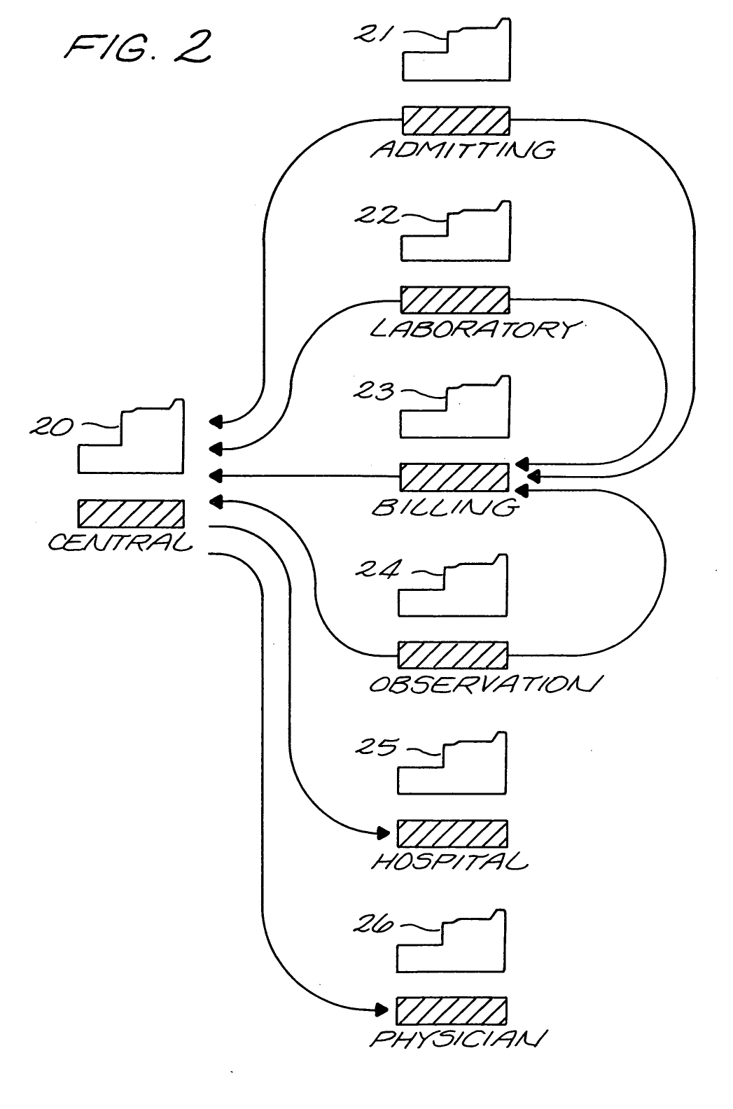

FIG. 2 is a flow diagram showing the flow of digital information within the preferred embodiment of the invention.

Central computer 20 serves as central depository for the digital data being collected and distributed. Central computer 20 is held within the emergency care facility 10 described in FIG. 1.

When the patient is first admitted, the patient's history is collected and entered onto the admitting computer 21. This information is sent along to the central computer 20, and is also transmitted to the billing computer 23 which keeps track of the patient charges and payments.

If tests are performed on the patient, then their results are entered onto laboratory computer 22 and communicated to both the central computer 20 and the billing computer 23.

The physician's and nursing observations (including the results of the physical examination) are entered on observation computer 24. This information is also communicated to the billing computer 23 and the central computer.

As the patient's bill is developed by billing computer 23, the results are communicated to the central computer 20. This results in a full collection of the data relative to the patient being stored on central computer 20.

The diagnostic results, as stored on central computer 20, is communicated to the physician's computer 26. This allows the primary care physician to keep abreast of the status of the patient and to take any needed action. In the preferred embodiment, the physician is notified via e-mail; the physician is then able to use their own personal code to access the information from the central computer 20.

In the preferred embodiment, the central computer 20, admitting computer 21, laboratory computer 22, billing computer 23, and observation computer 24 is all housed within the emergency care facility.

At the time that the patient is to be transported to the hospital, the hospital is given the complete diagnostic work-up by the central computer 20 and its connection with the hospital computer 25. Ideally this information is sent prior to the transportation of the patient; thereby allowing the hospital's staff to be fully prepared for the patient and ready to apply whatever treatment is needed without undue delay or repetitive testing.

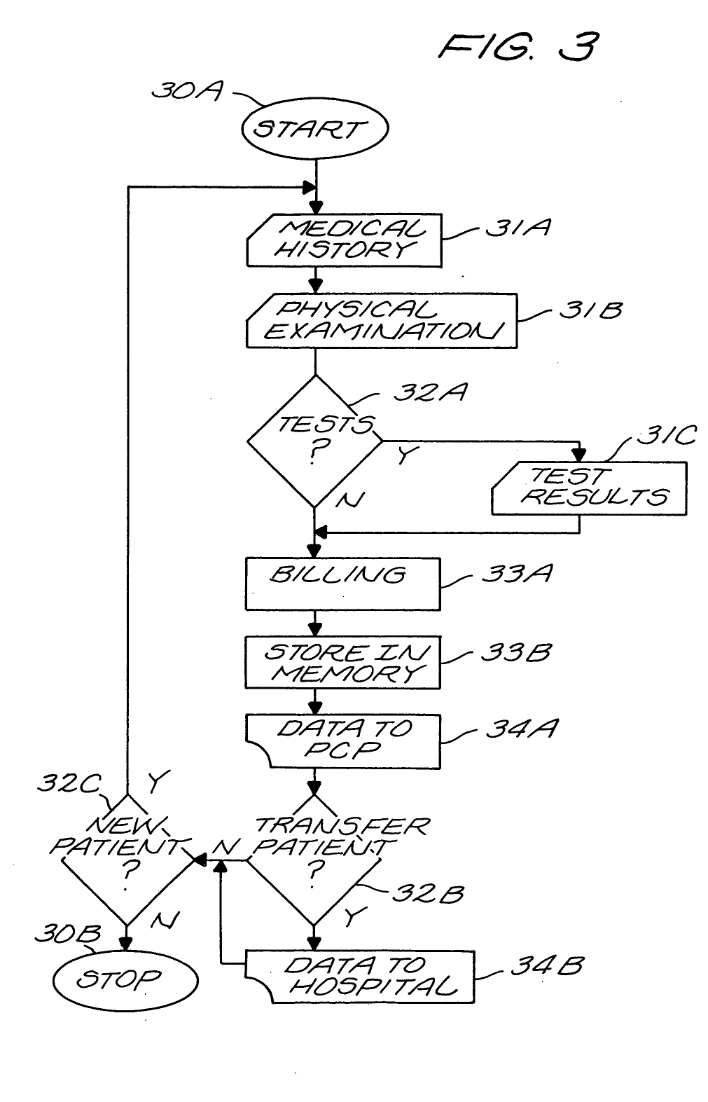

FIG. 3 is a flow-chart of the operation of the preferred embodiment of the computer operation.

Once the program starts 30A, the medical history is received 31A from the admitting computer as outlined in FIG. 2. The medical history is stored in memory and the physical examination data 31B is received and stored in memory.

If tests are to be performed, 32A, then the test results are also digitally received 31C and are stored into the memory. In this manner, the full description of the patient is collected in one location.

The billing 33A associated with the patient is performed and also stored in the memory 33B.

The data from memory is communicated to the primary care physician 34A. While this embodiment sends the entire data file to the primary care physician, other embodiments first electronically inform the primary care physician and then allows the physician to selectively acquire the data.

A determination is made on if the patient is being transferred 32B; if so, then the data is forwarded to the appropriate hospital 34B so that the physicians at the hospital are prepared for the arrival and treatment of the patient.

A determination is then made on if there is another patient 32C. If so, then the program cycles back to obtain the medical history; otherwise the program stops 30.

In this manner, patient care is stream-lined so that undue delays are eliminated.

It is clear that the present invention provides for the needed flow of information within the health-care industry.

1. A method of providing medical treatment comprising the steps of:
a) receiving a patient in an emergency situation;
b) diagnosing said patient;
c) digitally storing all aspects of the diagnosis on a computer; and,
d) providing treatment based upon said diagnosis for a period not to exceed twenty-four hours.

2. The method of providing medical treatment according to claim 1, wherein the step of diagnosing said patient includes the steps of:
a) taking a medical history of the patient;
b) conducting a physical examination of the patient; and,
c) performing tests on the patient.

3. The method of providing medical treatment according to claim 2, wherein the step of performing tests on the patient includes the step of generating selected digital imaging of the patient.

4. The method of providing medical treatment according to claim 3, wherein the step of generating digital imaging of the patient includes the step of creating a digital x-ray of a portion of the patient.

5. The method of providing medical treatment according to claim 4, further including the step of making the diagnosis of the patient digitally accessible to a remote care-facility.

6. The method of providing medical treatment according to claim 5, further including:
a) automatically and electronically notifying a primary care physician of the patient; and,
b) digitally providing access to the diagnosis to the primary care physician.

7. The method of providing medical treatment according to claim 5, further including the step of transporting the patient to the remote care-facility.

8. An emergency care method comprising the steps of:
a) diagnosing a patient within a facility remote from a hospital;
b) digitally storing all aspects of the diagnosis on a computer; and,
c) providing treatment based upon said diagnosis for a period not to exceed twenty-four hours.

9. The method according to claim 8,
a) wherein the step of diagnosing said patient includes the steps of
1) taking a medical history of the patient,
2) conducting a physical examination of the patient, and,
3) performing tests on the patient; and,
b) wherein the step of digitally storing all aspects of the diagnosis includes the step of, under a reference for the patient, digitally storing the medical history, physical examination results, and tests of the patient.

10. The method according to claim 9, wherein the step of performing tests on the patient includes the step of generating selected digital imaging of the patient.

11. The method according to claim 10, wherein the step of generating digital imaging of the patient includes the step of creating a digital x-ray of a portion of the patient.

12. The method according to claim 11, further including:
a) automatically and electronically notifying a primary care physician of the patient; and,
b) digitally providing access to the diagnosis to the primary care physician.

13. The method according to claim 11, further including the step of making the diagnosis of the patient digitally accessible to a remote care-facility.

14. The method according to claim 13, further including the step of transporting the patient to the remote care-facility.

15. A method of providing medical treatment comprising the steps of:
a) receiving a patient in an emergency situation;
b) diagnosing said patient by,
1) taking a medical history of the patient,
2) conducting a physical examination of the patient, and,
3) performing tests on the patient;
c) digitally storing all aspects of the diagnosis on a computer; and,
d) providing treatment based upon said diagnosis for a period not to exceed twenty-four hours.

16. The method of providing medical treatment according to claim 15, further including:
a) automatically and electronically notifing a primary care physician of the patient; and,
b) digitally providing access to the diagnosis to the primary care physician.

17. The method of providing medical treatment according to claim 15, wherein the step of performing tests on the patient includes the step of generating selected digital imaging of the patient.

18. The method of providing medical treatment according to claim 17, wherein the step of generating digital imaging of the patient includes the step of creating a digital x-ray of a portion of the patient.

19. The method of providing medical treatment according to claim 18, further including the step of making the diagnosis of the patient digitally accessible to a remote care-facility.

20. The method of providing medical treatment according to claim 19, further including the step of transporting the patient to the remote care-facility.
